(19) United States
(12) Patent Application Publication
(10) Pub. No.: US 2024/0402438 A1
(43) Pub. Date: Dec. 5, 2024

(54) FERRULE HOLDING STRUCTURE

(71) Applicant: Fujikura Ltd., Tokyo (JP)

(72) Inventor: Shuhei Kanno, Sakura-shi (JP)

(73) Assignee: Fujikura Ltd., Tokyo (JP)

(21) Appl. No.: 18/696,779

(22) PCT Filed: Apr. 18, 2022
(86) PCT No.: PCT/JP2022/018026

§ 371 Date: Mar. 28, 2024

(30) Foreign Application Priority Data
Oct. 20, 2021 (JP) 2021-171545

(51) Int. Cl. G02B 6/38

(52) U.S. Cl. CPC G02B 6/3871

(57) ABSTRACT

A ferrule holding structure includes an optical fiber, a ferrule into which the optical fiber is inserted from a rear end of the ferrule to a connection surface at a front end of the ferrule and that holds the optical fiber, a biasing member biasing the ferrule in a forward direction from the rear end toward the connection surface, a housing accommodating the biasing member and at least a part of the ferrule, a support member engaged with the housing and supporting a rear end side of the biasing member, and a rotation mechanism, structured with a part of the support member and a part of the housing, that rotatably attaches the support member to the housing. The support member includes a pressing surface that presses the biasing member in the forward direction along with a rotation of the support member with respect to the housing.

### CROSS-REFERENCE TO RELATED APPLICATIONS

The present application claims priority to Japanese Patent Application No. 2021-171545, filed Oct. 20, 2021. The contents of this application are incorporated herein by reference in their entirety.

### BACKGROUND

### Technical Field

The present invention relates to a ferrule holding structure.

### Description of the Related Art

In the related art, optical connectors for connecting optical fibers to each other have been widespread. With the recent increase in optical communication speed, optical connectors with multiple optical fibers are being used more than optical connectors with a single optical fiber.

Patent Document 1 discloses an optical connector with multiple optical fibers referred to as a multi-fiber push on (MPO) connector. In this type of optical connector has a structure in which a plurality of optical fibers are held in one ferrule and the ferrule is held by interposing the ferrule and a biasing member (spring) that biases the ferrule between a housing and a support member (spring push). A biasing force (pressing force) of the biasing member is necessary to press connection surfaces of the ferrule, where the plurality of optical fibers are exposed, against each other to ensure mechanical connection (that is, connection between an optical fiber and another optical fiber) of each optical connector.

Patent Document 2 discloses an MPO connector similar to Patent Document 1. Further, Patent Document 2 discloses that an MPO connector is inserted into an adapter in order to be connected to another MPO connector or the like.

### PATENT DOCUMENTS

Patent Document 1: Published Japanese Translation No. 2018-508045 of the PCT International Publication
Patent Document 2: Japanese Patent Publication No. 2018-092125

Although assembly of the holding structure of a ferrule (ferrule holding structure), such as in an optical connector described above in the related art, has been performed in a factory until now, in recent years, it has become increasingly common that assembly is performed by workers at a site where optical fibers are installed.

The assembly of the ferrule holding structure is performed by interposing the ferrule and a biasing member between a housing and a support member that engages with the housing in an extending direction of the optical fiber. Here, in the ferrule holding structure, the required pressing force of the biasing member (hereinafter, referred to as spring pressure) is increased in proportion to the number of optical fibers (number of cores) held by the ferrule. For example, in the ferrule holding structure (optical connector) in which the ferrule holds 12 optical fibers, the required spring pressure is 10 N. Further, in the ferrule holding structure (optical connector) in which the ferrule holds 24 optical fibers, the required spring pressure is 20 N.

When the ferrule holding structure is assembled at the factory, even when the spring pressure is high, the ferrule and the biasing member can be interposed between the housing and the support member by using an appropriate jig or device (large-scale jig or device) for assembly. However, in a case where the above-described jig or device cannot be used at a site, when the spring pressure is high, it becomes difficult to interpose the ferrule and the biasing member between the housing and the support member. That is, there is a case where it becomes difficult to assemble the ferrule holding structure.

### SUMMARY

One or more embodiments provide a ferrule holding structure that is capable of easily performing assembly at a site without any special jigs or devices.

A ferrule holding structure according to one or more embodiments includes: an optical fiber; a ferrule into which the optical fiber is inserted from a rear end to a connection surface as a front end so that the ferrule holds the optical fiber; a biasing member biasing the ferrule in a forward direction from the rear end toward the connection surface; a housing accommodating at least a part of the ferrule and the biasing member inside the housing; a support member engaged with the housing and supporting a rear end side of the biasing member; and a rotation mechanism structured with a part of the support member and a part of the housing, and rotatably attached the support member to the housing. The support member includes a pressing surface that is configured to press the biasing member in the forward direction a rotation of the support member with respect to the housing by the rotation mechanism.

According to one or more embodiments, the assembly of a ferrule holding structure can be easily performed at a site without any special jigs or devices.

### BRIEF DESCRIPTION OF THE DRAWINGS

FIG. 1 is a perspective view of a ferrule holding structure according to one or more embodiments, showing a state in which one support member does not support a rear end side of a biasing member.

FIG. 2 is a cross-sectional view taken along the line II-II in FIG. 1.

FIG. 3 is a cross-sectional view taken along the line III-III in FIG. 1.

FIG. 4 is a perspective view showing a state in which one ferrule unit is detached from a housing in the ferrule holding structure in FIG. 1.

FIG. 5 is a disassembled perspective view showing an optical fiber, a biasing member, a tubular member, and a spacer member in the ferrule unit in FIG. 4.

FIG. 6 is a side view showing a main portion of the ferrule holding structure in FIG. 1 in an enlarged manner.

FIG. 7 is a side view showing a process from a state shown in FIG. 6 until a rear end of the biasing member is supported by the support member.

FIG. 8 is a cross-sectional view showing a state corresponding to FIG. 7.

FIG. 9 is a side view showing a process subsequent to FIG. 7.

FIG. 10 is a cross-sectional view showing a state corresponding to FIG. 9.

FIG. 11 is a side view showing a process subsequent to FIG. 9 and corresponding to a state in which the support member supports the rear end of the biasing member.

FIG. 12 is a cross-sectional view corresponding to FIG. 11 showing a state in which the support member supports the rear end of the biasing member.

FIG. 13 is a side view showing a process from a state shown in FIG. 11 to releasing the support of the biasing member by the support member.

FIG. 14 is a cross-sectional view showing a process corresponding to FIG. 13.

FIG. 15 is a side view showing a process subsequent to FIGS. 13 and 14.

### DESCRIPTION OF THE EMBODIMENTS

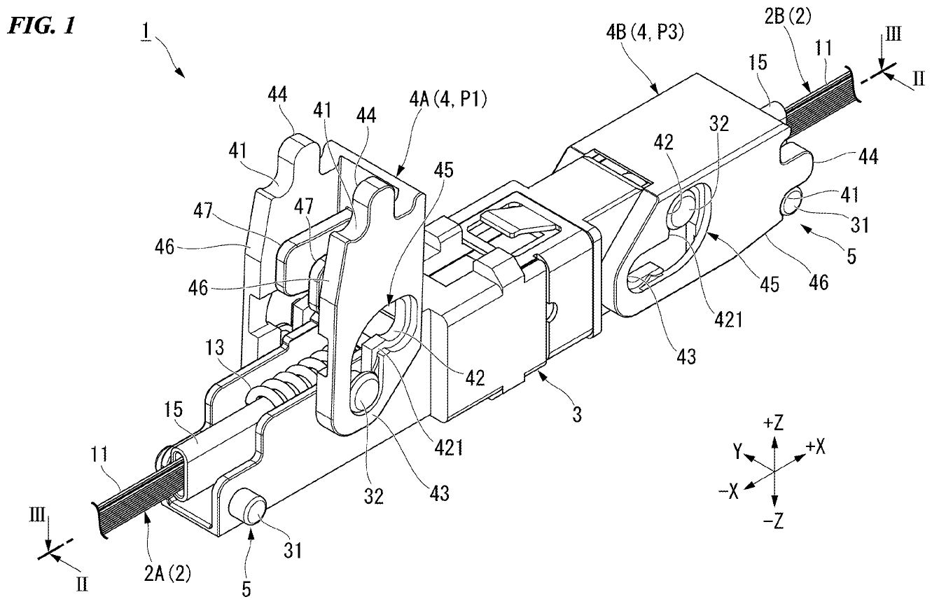

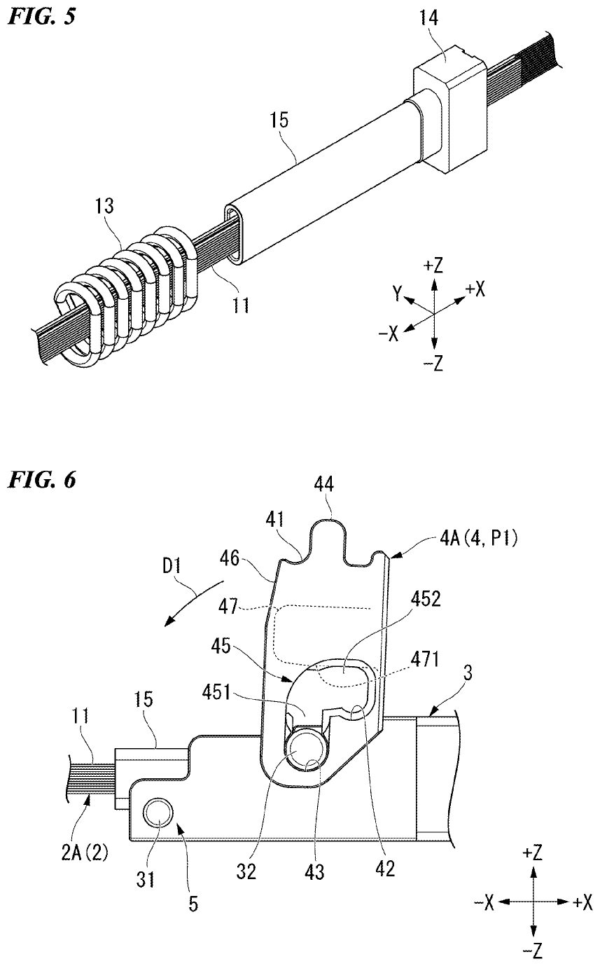

Hereinafter, embodiments will be described with reference to FIGS. 1 to 8.

As shown in FIGS. 1 to 3, a ferrule holding structure 1 of one or more embodiments configures an optical connector for connecting optical fibers 11 held by the ferrule 12 to each other.

The ferrule holding structure 1 includes ferrule units 2 (2A, 2B), a housing 3, support members 4 (4A, 4B), and a rotation mechanism 5. The ferrule unit 2 connects the optical fiber 11 included therein to an optical fiber 11 of another ferrule unit 2. The ferrule holding structure 1 of one or more embodiments includes two ferrule units 2. The housing 3 is configured as an adapter for connecting the two ferrule units 2. In the following description, one of the two ferrule units 2 may be referred to as a first ferrule unit 2A, and the other may be referred to as a second ferrule unit 2B.

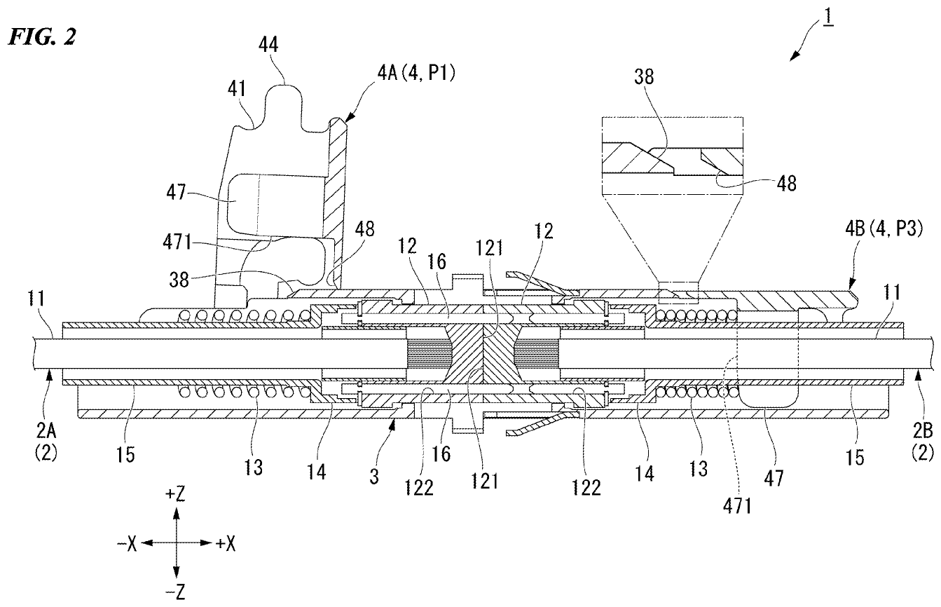

As shown in FIGS. 2 to 4, the first ferrule unit 2A includes an optical fiber 11, a ferrule 12, and a biasing member 13. The first ferrule unit 2A further includes a spacer member 14 and a tubular member 15. The ferrule 12 includes a connection surface 121 into which the optical fiber 11 is inserted and a tip of the optical fiber 11 is exposed.

In the following description, a direction in which the optical fiber 11 is inserted into the ferrule 12 is referred to as a forward-rearward direction X. Further, in the first ferrule unit 2A, a connection surface 121 side of the ferrule 12 in the forward-rearward direction X is referred to as a forward direction (+X), and an opposite side is referred to as a rearward direction (−X). One direction (second orthogonal direction) orthogonal to the forward-rearward direction X is referred to as an upward-downward direction Z. Further, one side in the upward-downward direction Z is referred to as an upward direction (+Z), and the other side is referred to as a downward direction (−Z). A direction orthogonal to both the forward-rearward direction X and the upward-downward direction Z (first orthogonal direction) is called a left-right direction Y.

The ferrule 12 holds the optical fiber 11 by inserting the optical fiber 11 from a rear end to the connection surface 121 as a front end. The tip of the optical fiber 11 is exposed on the connection surface 121 of the ferrule 12. The number of optical fibers 11 held by the ferrule 12 (the number of optical fibers 11 exposed on the connection surface 121) may be any number.

The ferrule 12 includes a guide hole 122 penetrating in the forward-rearward direction X from the connection surface 121 (front end) to the rear end. A guide pin 16 can be inserted into the guide hole 122. The guide pin 16 positions the ferrule 12 of the first ferrule unit 2A and the ferrule 12 of the second ferrule unit 2B relative to each other. In one or more embodiments, the guide pin 16 is attached to the ferrule 12 of the first ferrule unit 2A. The guide pin 16 is inserted into the guide hole 122 of the ferrule 12 of the second ferrule unit 2B when the connection surfaces 121 of the ferrules 12 of the first and second ferrule units 2A and 2B are in abutting each other.

The biasing member 13 is disposed on a rear end side of the ferrule 12 and biases the ferrule 12 in the forward direction from the rear end toward the connection surface 121 (front end). The biasing member 13 may have any specific configuration. The biasing member 13 in one or more embodiments is a coil spring. Although the coil spring in the shown example is an elliptical shape with a long diameter in the upward-downward direction Z when viewed from the forward-rearward direction X, the coil spring may have a circular shape, for example.

The spacer member 14 is provided between the ferrule 12 and the biasing member 13. The spacer member 14 supports a front end of the biasing member 13 positioned on a ferrule 12 side. Although not shown, the spacer member 14 is formed with an insertion hole into which the optical fiber 11 extending in the rear side of the ferrule 12 (rearward direction) is inserted on the rear side. The spacer member 14 of one or more embodiments also functions as a pin clamp that holds the above-described guide pin 16.

As shown in FIGS. 2 to 5, the tubular member 15 is disposed on the rear end side of the ferrule 12 such that an axial direction thereof extends in the forward-rearward direction X. The optical fiber 11 extending on the rear side of the ferrule 12 is inserted into the tubular member 15. Further, the tubular member 15 is inserted inside the biasing member 13, which is a coil spring. In such a state, the biasing member 13 is positioned in an outer peripheral side of the tubular member 15. In one or more embodiments, the tubular member 15 is integrally formed with the spacer member 14.

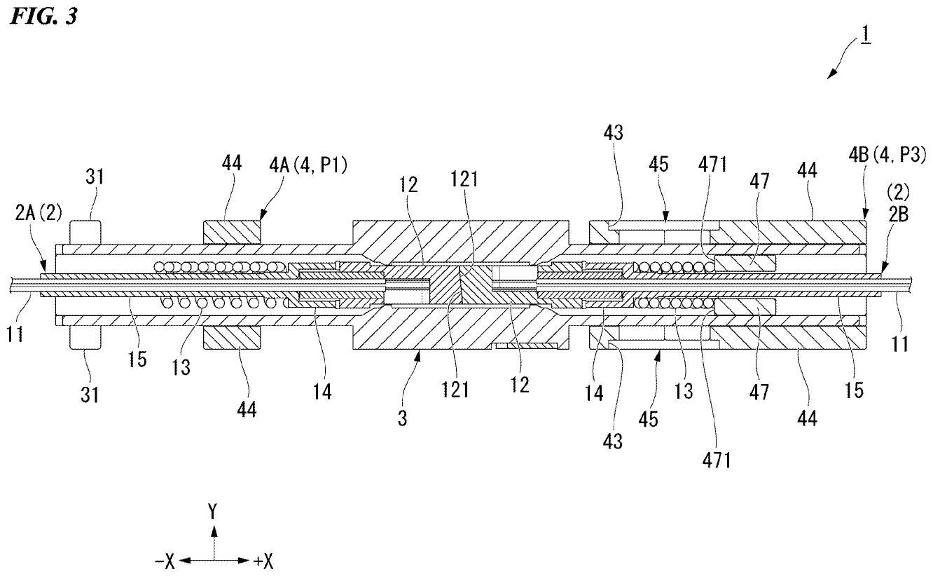

As shown in FIGS. 2 and 3, the configuration of the second ferrule unit 2B is similar to the configuration of the first ferrule unit 2A described above. However, in the second ferrule unit 2B, the −X direction of the forward-rearward direction X corresponds to the forward direction of the ferrule 12, and the +X direction corresponds to the rearward direction of the ferrule 12. That is, the second ferrule unit 2B faces a side opposite to the first ferrule unit 2A in the forward-rearward direction X. As a result, the connection surfaces 121 of the ferrules 12 of the first and second ferrule units 2A and 2B face each other in the forward-rearward direction X.

As shown in FIGS. 1 to 4, the housing 3 is formed in a tubular shape extending in the forward-rearward direction X. The housing 3 accommodates the ferrule 12 and the biasing member 13 therein. In one or more embodiments, the spacer member 14 and the tubular member 15 are also accommodated inside the housing 3. In the shown example, each of the ferrule 12, the biasing member 13, and the spacer member 14 are all accommodated in the housing 3. Further, a part of the tubular member 15 is accommodated in the housing 3, and a rear end portion (remaining portion) of the tubular member 15 is positioned outside the housing 3 in the forward-rearward direction X. The ferrule 12, which is accommodated inside the housing 3, is restricted by the housing 3 so as not to move in the forward direction beyond a predetermined position with respect to the housing 3.

The first ferrule unit 2A is accommodated in the housing 3 by being inserted into the housing 3 with the +X direction as the forward direction. The second ferrule unit 2B is accommodated in the housing 3 by being inserted into the housing 3 with the −X direction as the forward direction. That is, the first and second ferrule units 2A and 2B are inserted into the housing 3 opposite to each other in the forward-rearward direction X. As a result, the connection surfaces 121 of each of the ferrules 12 of the first and second ferrule units 2A and 2B can be abutted against each other.

The support member 4 (spring push) supports the rear end side of the biasing member 13 by being engaged with the housing 3. In a state in which the support member 4 is engaged with the housing 3, the ferrule 12 and the biasing member 13 which are accommodated in the housing 3 are interposed between the support member 4 and the housing 3 in the forward-rearward direction X. In such a state, the biasing member 13 is elastically compressed in the forward-rearward direction X and biases the ferrule 12 in the forward direction.

The ferrule holding structure 1 of one or more embodiments includes two support members 4. Among the two support members 4, a first support member 4A corresponds to the first ferrule unit 2A, and a second support member 4B corresponds to the second ferrule unit 2B.

In FIGS. 1 to 3, the first support member 4A is disposed at a position where the rear end of the biasing member 13 of the first ferrule unit 2A is not supported, that is, is not engaged with the housing 3. Therefore, the biasing member 13 of the first ferrule unit 2A is not elastically compressed and does not bias the ferrule 12 of the first ferrule unit 2A in the forward direction (+X direction). On the other hand, the second support member 4B is disposed at a position where the rear end of the biasing member 13 of the first ferrule unit 2A is supported, that is, is engaged with the housing 3. As a result, the biasing member 13 of the second ferrule unit 2B is elastically compressed and biases the ferrule 12 of the second ferrule unit 2B in the forward direction (−X direction).

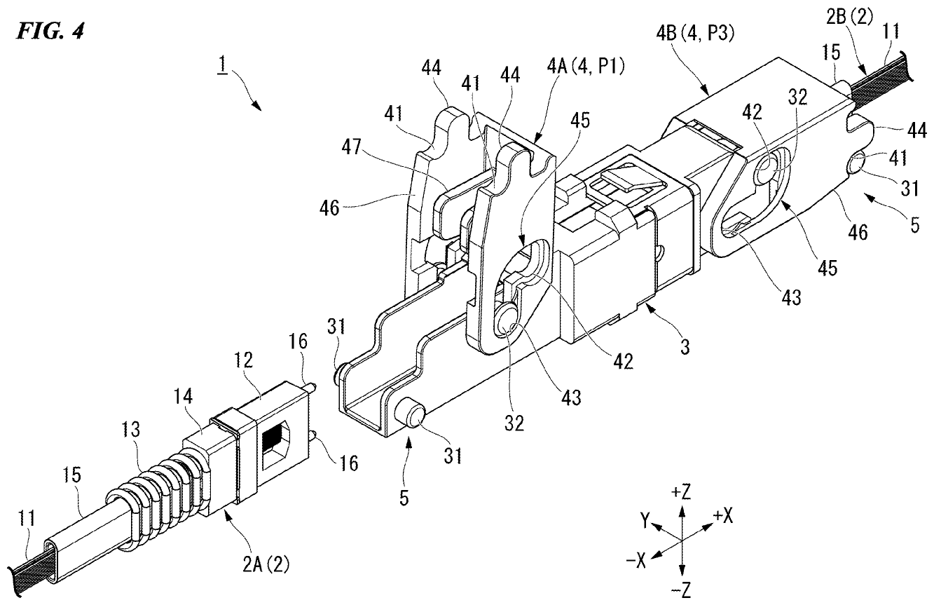

The rotation mechanism 5 shown in FIGS. 1 and 4 is a mechanism that rotatably attaches the support member 4 to the housing 3. As shown in FIGS. 2, 3, and 9 to 12, the support member 4 includes a pressing surface 471 for pressing the biasing member 13 in the forward direction as the support member 4 is rotated with respect to the housing 3 by the rotation mechanism 5.

Hereinafter, the rotation mechanism 5 of one or more embodiments will be specifically described.

As shown in FIGS. 1 and 4, the rotation mechanism 5 is composed of a part of the support member 4 and a part of the housing 3. That is, the rotation mechanism 5 includes a first shaft support portion 31 and a second shaft support portion 32, which are provided in the housing 3, and a first recess 41 and a second recess 42, which are provided in the support member 4.

The first shaft support portion 31 and the second shaft support portion 32 of the housing 3 extend in the left-right direction Y (first orthogonal direction). In one or more embodiments, the first shaft support portion 31 and the second shaft support portion 32 extend outside from outer surfaces of both sides of the housing 3 in the left-right direction Y at an end portion of the housing 3 in the forward-rearward direction X. Further, the first shaft support portion 31 and the second shaft support portion 32 each function as rotation center axes for the first recess 41 and the second recess 42 (and a third recess 43 to be described later).

The first shaft support portion 31 and the second shaft support portion 32 are positioned at an interval in the forward-rearward direction X. In one or more embodiments, the first shaft support portion 31 is positioned in the rearward direction with respect to the second shaft support portion 32. For example, the first shaft support portion 31 corresponding to the first support member 4A is positioned in the −X direction with respect to the second shaft support portion 32. Further, the first shaft support portion 31 is positioned in the downward direction with respect to the second shaft support portion 32.

The support member 4 to be described later is hooked on the first shaft support portion 31 and the second shaft support portion 32 of the housing 3. In a state in which the support member 4 is hooked on the first shaft support portion 31 or the second shaft support portion 32, the support member 4 is rotatable with respect to the housing 3 around the first shaft support portion 31 or the second shaft support portion 32.

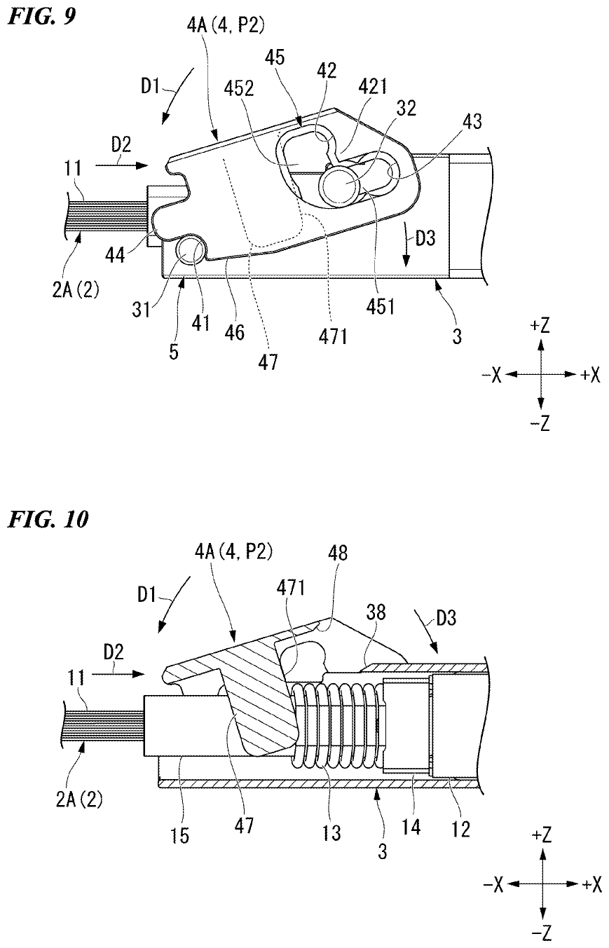

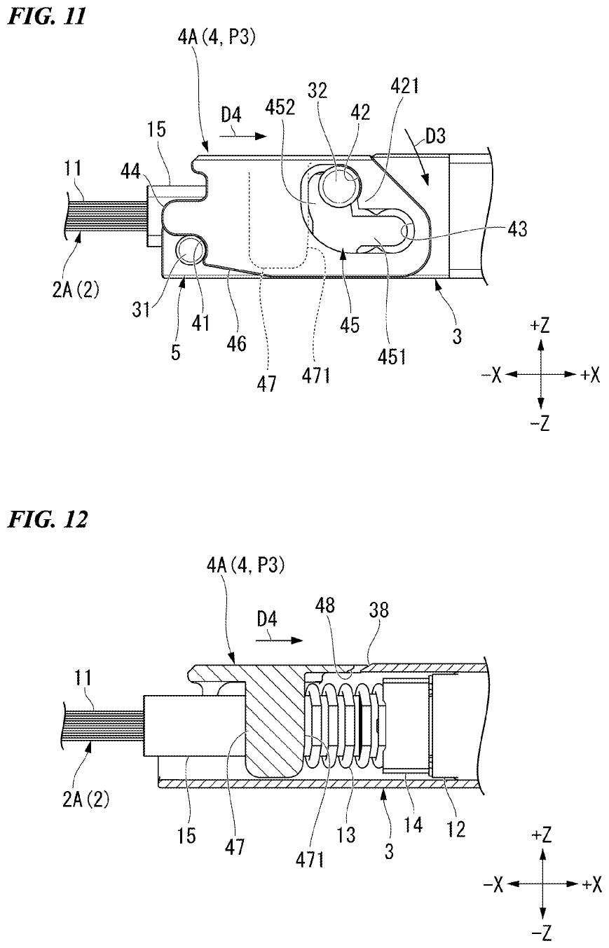

As shown in FIGS. 9 and 11, the first shaft support portion 31 of the housing 3 can be fitted into the first recess 41 of the support member 4. In a state in which the first shaft support portion 31 is fitted into the first recess 41, the support member 4 is rotatable around the first shaft support portion 31. Further, as shown in FIG. 11, the second shaft support portion 32 of the housing 3 can be fitted into the second recess 42 of the support member 4. Relative positions of the first recess 41 and the second recess 42 of the support member 4 correspond to relative positions of the first shaft support portion 31 and the second shaft support portion 32 of the housing 3. That is, the first recess 41 and the second recess 42 are positioned at an interval in a predetermined direction. Further, as shown in FIG. 11, in a state in which the support member 4 is disposed such that the first recess 41 and the second recess 42 are substantially aligned in the forward-rearward direction X (a state in which the support member 4 is disposed at a second position P3), the first recess 41 is positioned in the rearward direction with respect to the second recess 42. For example, the first recess 41 of the first support member 4A is positioned in the −X direction with respect to the second recess 42. Further, the first recess 41 is positioned in the downward direction with respect to the second recess 42. Therefore, in a state in which the support member 4 is disposed at the second position P3, the first shaft support portion 31 can be fitted into the first recess 41 of the support member 4, and the second shaft support portion 32 can be fitted into the second recess 42 at the same time.

Further, the first recess 41 and the second recess 42 are recessed in the same direction as each other. For example, as shown in FIG. 11, in a state in which the support member 4 is disposed at the second position P3, the first recess 41 and the second recess 42 are recessed in the forward direction. For example, the first recess 41 and the second recess 42 corresponding to the first support member 4A are recessed in the +X direction.

As a result, in a state in which the support member 4 is disposed at the second position P3, the first recess 41 is positioned in the forward direction side of the first shaft support portion 31, and the first shaft support portion 31 is fitted into the first recess 41 in the forward direction. Similarly, the second recess 42 is positioned in the forward direction side of the second shaft support portion 32, and the second shaft support portion 32 is fitted into the second recess 42 in the forward direction.

As shown in FIGS. 9 and 11, in a state in which the first shaft support portion 31 is fitted into the first recess 41, the pressing surface 471 of the support member 4 presses the biasing member 13 in the forward direction as the support member 4 is rotated around the first shaft support portion 31 from the first position P2 shown in FIGS. 9 and 10 to the second position P3 shown in FIGS. 11 and 12. In FIGS. 9 to 12, the support member 4 is rotated clockwise (D3 direction) about the first shaft support portion 31. When the support member 4 reaches the second position P3, the second shaft support portion 32 is fitted into the second recess 42 of the support member 4. In such a state, because the support member 4 is pressed in the rearward direction with the biasing force of the biasing member 13, the first and second shaft support portions 31 and 32 are held in a state in which the first and second shaft support portions 31 and 32 are fitted into the first and second recesses 41 and 42.

Further, in the state shown in FIGS. 11 and 12, the second recess 42 restricts the rotational movement of the support member 4 from the second position P3 toward the first position P2 (see FIGS. 9 and 10) around the first shaft support portion 31. Specifically, the second recess 42 includes a locking portion 421 positioned on the rear side (front side in D3 direction) in a rotational direction of the support member 4 from the second position P3 toward the first position P2 with respect to the second shaft support portion 32 that is fitted into the second recess 42. Such a locking portion 421 restricts the rotational movement of the support member 4 from the second position P3 to the first position P2.

As described above, in a state in which the support member 4 is disposed at the second position P3, the support member 4 is held at a position where the pressing surface 471 presses the biasing member 13 in the forward direction. In such a state, the biasing member 13 is interposed between the housing 3 and the support member 4 in a compressed manner. That is, the second position P3 of the support member 4 is an engagement position where the support member 4 is engaged with the housing 3 to support the rear end side of the biasing member 13.

In a state in which the support member 4 is disposed at the above-described second position P3, the rearward direction side of the first shaft support portion 31, which is fitted into the first recess 41, and the rearward direction side of the second shaft support portion 32, which is fitted into the second recess 42, are each open. Therefore, the support member 4 can move in the forward direction against the biasing force of the biasing member 13 from a state in which the support member 4 is disposed at the second position P3. By moving the support member 4 in the forward direction from the second position P3, the first recess 41 and the second recess 42 can each be separated from the first shaft support portion 31 and the second shaft support portion 32 of the housing 3. As a result, it is possible to release the engagement state between the housing 3 and the support member 4 to release the biasing member 13 from being interposed between the housing 3 and the support member 4.

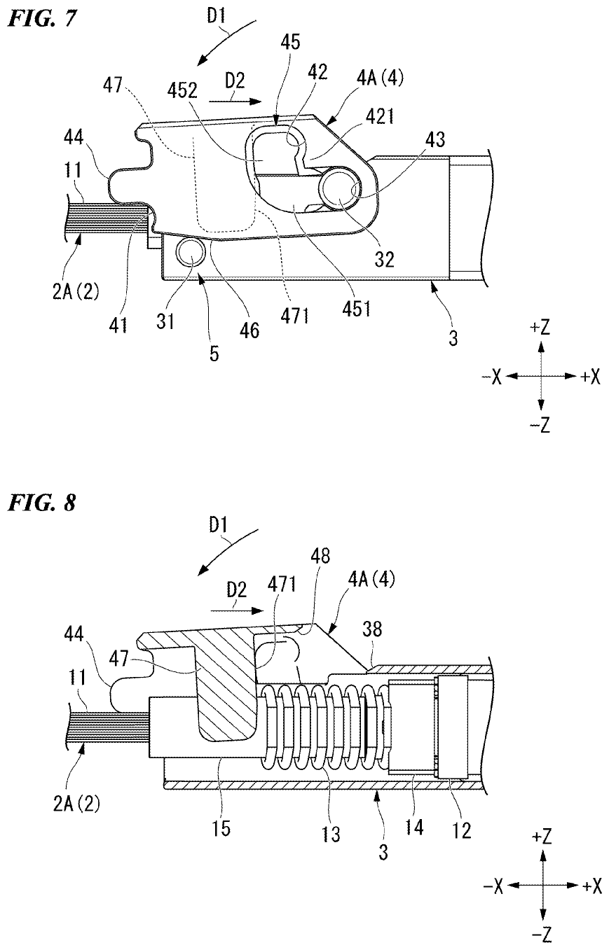

The rotation mechanism 5 of one or more embodiments further includes the third recess 43 provided in the support member 4. As shown in FIGS. 6 and 7, the third recess 43 is configured such that the support member 4 is rotatable around the second shaft support portion 32 with respect to the housing 3 when the second shaft support portion 32 of the housing 3 is fitted into the third recess 43.

As shown in FIG. 11, similarly to the first recess 41, the third recess 43 is positioned in the downward direction with respect to the second recess 42 in a state in which the support member 4 is disposed at the second position P3. Further, the third recess 43 is positioned in the forward direction with respect to the second recess 42. For example, the third recess 43 of the first support member 4A is positioned in the +X direction with respect to the second recess 42.

Therefore, for example, as shown in FIG. 7, even when the first recess 41 and the third recess 43 are disposed to be substantially aligned in the forward-rearward direction X in a state in which the second shaft support portion 32 is fitted into the third recess 43, the first shaft support portion 31 is positioned further in the rearward direction than the first recess 41. Therefore, the first shaft support portion 31 is not fitted into the first recess 41 in a state in which the second shaft support portion 32 is fitted into the third recess 43.

As shown in FIG. 11, in a state in which the support member 4 is disposed at the second position P3, the third recess 43 is recessed in the same forward direction as the first recess 41 and the second recess 42. For example, the third recess 43 corresponding to the first support member 4A is recessed in the +X direction.

Furthermore, in a state in which the support member 4 is disposed at the second position P3, the rearward direction side of the third recess 43 is open similarly to that of the first and second recesses 41 and 42. Therefore, for example, as shown in FIG. 7, from a state in which the support member 4 is disposed such that the second shaft support portion 32 is fitted into the third recess 43 and the first recess 41 and the third recess 43 are substantially aligned in the forward-rearward direction X, the support member 4 can be moved in the forward direction (+X direction in FIG. 7). Since the support member 4 can be moved in the forward direction, the first shaft support portion 31 can be fitted into the first recess 41.

In a state in which the support member 4 is disposed at the position shown in FIG. 7, the pressing surface 471 of the support member 4 does not press the biasing member 13 in the forward direction as shown in FIG. 8. When the first shaft support portion 31 is fitted into the first recess 41 as shown in FIG. 9 by moving the support member 4 in the forward direction from a state shown in FIGS. 7 and 8, the pressing surface 471 of the support member 4 presses the biasing member 13 in the forward direction as shown in FIG. 10.

As shown in FIGS. 1, 3, and 4, the first recess 41, the second recess 42, and the third recess 43 of the support member 4 described above are each formed on side walls 44 of the support member 4 disposed on both outer sides of the housing 3 in the left-right direction Y. As a result, the first shaft support portions 31 positioned on both the left and right sides can be fitted into the first recesses 41 positioned on the left and right sides. Further, the first shaft support portion 31 and the second shaft support portion 32, which are positioned on both the left and right sides, can be fitted into the second recess 42 and the third recess 43 positioned on the left and right sides.

In one or more embodiments, the second recess 42 and the third recess 43 of the support member 4 are formed at an edge of the same through hole 45 that penetrates each side wall 44 of the support member 4 in the left-right direction Y (direction where the second shaft support portion 32 extends). The through hole 45 is not open to an outer edge of the side wall 44 when the side wall 44 is viewed in the left-right direction Y. Further, the second shaft support portions 32 positioned on both sides of the housing 3 in the left-right direction Y are each inserted through the through hole 45 of each side wall 44 of the support member 4. As a result, the support member 4 is suppressed or prevented from coming off the housing 3.

As shown in FIG. 11, the through hole 45, which is formed in the support member 4, includes a first passage 451 that extends on the rear side from the third recess 43, and a second passage 452 that extends in the upward direction from a rear end of the first passage 451 and that is connected with a space on a rear side of the second recess 42, in a state in which the support member 4 is disposed at the second position P3. When the second shaft support portion 32 is moved between the second recess 42 and the third recess 43, the second shaft support portion 32 may pass through the first and second passages 451 and 452 of the through hole 45.

As shown in FIGS. 6 and 7, the support member 4 of one or more embodiments further includes a sliding inclination surface 46. The sliding inclination surface 46 is a surface that comes into contact with the first shaft support portion 31 when the support member 4 is rotated to one side (D1 direction in FIGS. 6 and 7) around the second shaft support portion 32 such that the first recess 41 of the support member 4 approaches the first shaft support portion 31 of the housing 3, in a state in which the second shaft support portion 32 is fitted into the third recess 43. The sliding inclination surface 46 is positioned on a front side of the first recess 41 in the D1 direction. The sliding inclination surface 46 is inclined on the rear side of the support member 4 in the rotational direction (D1 direction) described above with respect to a radial direction around the second shaft support portion 32.

As a result, as shown in FIG. 7, when the support member 4 is further rotated in the D1 direction from a state in which the sliding inclination surface 46 of the support member 4 comes into contact with the first shaft support portion 31, as the first shaft support portion 31 slides on the sliding inclination surface 46, the support member 4 is moved in the forward direction (D2 direction in FIG. 7), and the second shaft support portion 32 is separated from the third recess 43 in the rearward direction. As a result, as shown in FIG. 9, the first shaft support portion 31 can be fitted into the first recess 41.

As shown in FIGS. 11 and 12, the pressing surface 471 of the support member 4, which is pressed against the rear end of the biasing member 13, is a surface that faces in the forward direction side in a state in which the support member 4 is disposed at the second position P3. The pressing surface 471 of one or more embodiments is a surface orthogonal to the forward-rearward direction X in a state in which the support member 4 is disposed at the second position P3. The pressing surface 471 may include, for example, a surface that is inclined with respect to both the forward-rearward direction X and the upward-downward direction Z or may be composed of only an inclined surface, in a state in which the support member 4 is disposed at the second position P3.

As shown in FIGS. 1 and 3, the support member 4 is movable with respect to the housing 3 on an outer peripheral side of the tubular member 15 of the ferrule unit 2 accommodated in the housing 3. The support member 4 is configured not to interfere with the tubular member 15 even when the support member 4 is moved with respect to the housing 3. Specifically, as shown in FIGS. 1 and 3, a portion including the pressing surface 471 of the support member 4 (pressing portion 47) is positioned between the side walls 44 at both left and right ends of the support member 4. Further, the pressing portions 47 are disposed to be positioned on both sides of the tubular member 15 in the left-right direction Y. As a result, even when the support member 4 is moved with respect to the housing 3, the pressing portion 47 of the support member 4 does not interfere with the tubular member 15.

Further, in the ferrule holding structure 1 of one or more embodiments, as shown in FIGS. 2 and 12, the housing 3 and the support member 4 include inclination guide surfaces 38 and 48. The inclination guide surfaces 38 and 48 are faces that are inclined in both the forward-rearward direction X and the upward-downward direction Z in a state in which the support member 4 is disposed at the second position P3. The inclination guide surface 38 of the housing 3 and the inclination guide surface 48 of the support member 4 face each other in the forward-rearward direction X in a state in which the support member 4 is disposed at the second position P3.

Specifically, the inclination guide surface 38 of the housing 3 is a surface that faces both the rearward direction and the upward direction and is inclined to face the upward direction as the inclination guide surface 38 is moved toward the forward direction. The inclination guide surface 48 of the support member 4 is a surface that faces both the forward direction and the downward direction in a state in which the support member 4 is disposed at the second position P3 and is inclined to face the upward direction as the inclination guide surface 48 is moved toward the forward direction. The inclination guide surface 48 of the support member 4 disposed at the second position P3 is parallel to the inclination guide surface 38 of the housing 3.

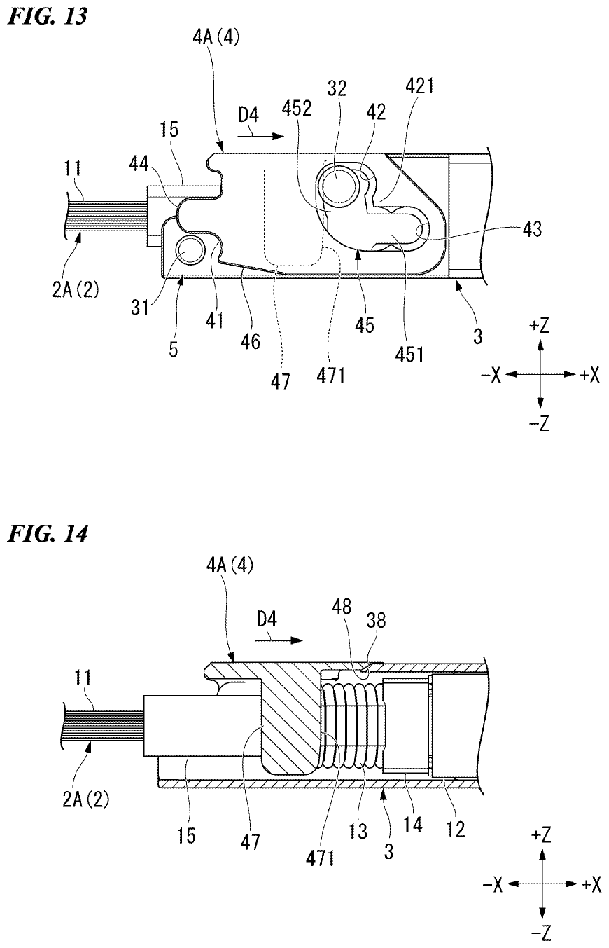

As a result, when the support member 4, which is disposed at the second position P3 as shown in FIGS. 11 and 12, is moved in the forward direction (D4 direction in FIGS. 11 to 14) as shown in FIGS. 13 and 14, the inclination guide surface 38 of the housing 3 and the inclination guide surface 48 of the support member 4 come into surface contact with each other. When the support member 4 is further moved in the forward direction, the inclination guide surface 38 of the housing 3 and the inclination guide surface 48 of the support member 4 slide to guide the support member 4 in the upward direction. That is, the support member 4 is moved in the upward direction with respect to the housing 3.

For example, only one member among the housing 3 and the support member 4 may include the above-mentioned inclination guide surface. In this case, the inclination guide surface of the one member may face the other member in the forward-rearward direction X in a state in which the support member 4 is disposed at the second position P3.

Next, in the ferrule holding structure 1 of one or more embodiments, a method of interposing the biasing member 13 between the housing 3 and the support member 4 will be described. In the following description, the procedure of interposing the biasing member 13 of the first ferrule unit 2A between the housing 3 and the first support member 4A will be described, and the same applies to the case of the second ferrule unit 2B.

In this method, as shown in FIGS. 1 to 3, the first ferrule unit 2A is inserted into and accommodated in the housing 3 in advance. When the first ferrule unit 2A is inserted into the housing 3, the first support member 4A is disposed at a retracted position P1. The retracted position P1 of the first support member 4A is a position where the pressing portion 47 (pressing surface 471) of the first support member 4A is retracted from an insertion-removal path of the first ferrule unit 2A with respect to the housing 3. As shown in FIGS. 1 and 6, in a state in which the first support member 4A is disposed at the retracted position P1, the second shaft support portion 32 of the housing 3 is fitted into the third recess 43 of the first support member 4A, and the first recess 41 and the pressing portion 47 are positioned in the third recess 43 in the upward direction.

In order to interpose the biasing member 13 between the housing 3 and the first support member 4A, first, as shown in FIGS. 6 to 8, the first support member 4A is rotated in the D1 direction around the second shaft support portion 32 from the retracted position P1, and the sliding inclination surface 46 of the first support member 4A comes into contact with the first shaft support portion 31 from the upper side. In this state, the pressing surface 471 of the first support member 4A is positioned at an interval in the rearward direction of the biasing member 13. Further, the first recess 41 of the first support member 4A is positioned in the rearward direction of the second and third recesses 42 and 43, and the second recess 42 is positioned in the upper part of the third recess 43.

Next, the first support member 4A is further rotated in the D1 direction. At this time, when the first shaft support portion 31 slides on the sliding inclination surface 46, as shown in FIGS. 7 to 10, the first support member 4A is moved in the forward direction (D2 direction). Further, the second shaft support portion 32 is separated in the rearward direction from the third recess 43 and is positioned in the first passage 451 of the through hole 45. As a result, the first support member 4A is further rotated in the D1 direction, and the first shaft support portion 31 is fitted into the first recess 41.

Further, when the first support member 4A is moved in the D2 direction, as shown in FIG. 10, the pressing surface 471 of the first support member 4A is pressed against the rear end of the biasing member 13 and presses the biasing member 13 in the forward direction. At this time, the length by which the pressing surface 471 presses the biasing member 13 in the forward direction is short. Therefore, the biasing force of the biasing member 13 acting on the first support member 4A as the pressing surface 471 presses the biasing member 13 is small. In the structure of one or more embodiments, a force for rotating the first support member 4A in the D1 direction is converted into a force for pressing the biasing member 13 in the forward direction by using the principle of the lever. Therefore, even when the force for rotating the first support member 4A in the D1 direction is small, and even when the biasing force of the biasing member 13 acting on the first support member 4A as the pressing surface 471 presses the biasing member 13 is large, the pressing surface 471 can press the biasing member 13 in the forward direction.

In a state shown in FIGS. 9 and 10, the biasing member 13 biases the first support member 4A in the rearward direction such that the first shaft support portion 31 is fitted into the first recess 41. That is, the biasing force of the biasing member 13 prevents or restrains the first shaft support portion 31 from coming out of the first recess 41. The position of the first support member 4A shown in FIGS. 9 and 10 is a “first position P2” described above.

Thereafter, as shown in FIGS. 9 to 12, the first support member 4A is rotated to one side (D3 direction) around the first shaft support portion 31 such that the second recess 42 of the first support member 4A approaches the second recess 42 of the housing 3 (that is, such that the front end portion of the first support member 4A is moved in the downward direction). As the first support member 4A is rotated in the D3 direction, the second shaft support portion 32 is moved to the upper part of the second passage 452 of the through hole 45, and the first support member 4A reaches the second position P3. When the first support member 4A reaches the second position P3, the second shaft support portion 32 is fitted into the second recess 42 positioned in the forward direction side at the upper end of the second passage 452.

Further, when the first support member 4A is rotated in the D3 direction, as shown in FIG. 12, the pressing surface 471 of the first support member 4A is further pressed against the rear end of the biasing member 13 and further presses the biasing member 13 in the forward direction. Therefore, the biasing force of the biasing member 13 acting on the first support member 4A as the pressing surface 471 of the first support member 4A presses the biasing member 13 is large. However, here, a force for rotating the first support member 4A in the D3 direction is converted into a force for pressing the biasing member 13 in the forward direction by using the principle of the lever. Therefore, even when the force for rotating the first support member 4A in the D3 direction is small, the pressing surface 471 can press the biasing member 13 in the forward direction.

As shown in FIGS. 11 and 12, in a state in which the first support member 4A is disposed at the second position P3, because the first support member 4A is pressed in the rearward direction with the biasing force of the biasing member 13, the first and second shaft support portions 31 and 32 are held in a state in which the first and second shaft support portions 31 and 32 are fitted into the first and second recesses 41 and 42. Further, in this state, the second recess 42 restricts the first support member 4A from rotating around the first shaft support portion 31 in a direction opposite to the D1 direction by the locking portion 421 thereof.

As a result, the first support member 4A is engaged with the housing 3 and is held in a state in which the first support member 4A supports the rear end side of the biasing member 13. That is, the biasing member 13 is held in a state in which the biasing member 13 is interposed between the housing 3 and the first support member 4A. As described above, the method of interposing the biasing member 13 of the first ferrule unit 2A between the housing 3 and the first support member 4A is completed. FIGS. 2 to 3 show a mode in which the biasing member 13 of the second ferrule unit 2B is held in a state of being interposed between the housing 3 and the second support member 4B.

Next, in the ferrule holding structure 1 of one or more embodiments, a method of releasing (releasing method) the biasing member 13 from being interposed between the housing 3 and the support member 4 will be described. In the following description, a procedure of releasing the interposing of the biasing members 13 of the first ferrule unit 2A will be described, and the same applies to the case of the second ferrule unit 2B.

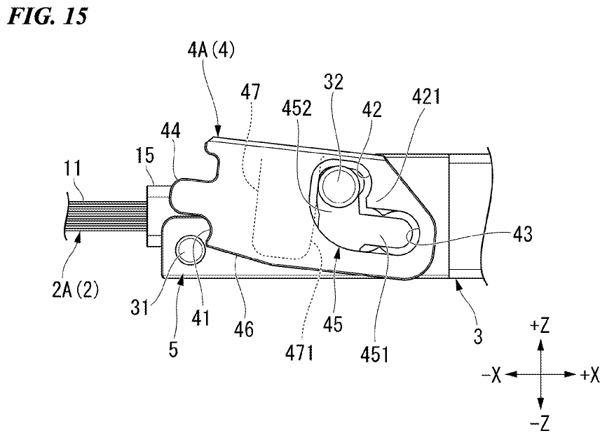

In order to release the interposing of the biasing member 13, from a state in which the first support member 4A is disposed at the second position P3 as shown in FIGS. 11 and 12, the first support member 4A is moved in the forward direction (D4 direction) as shown in FIGS. 13 and 14. As a result, the first and second recesses 41 and 42 of the first support member 4A are each separated from the first and second shaft support portions 31 and 32 of the housing 3 in the forward direction. As a result, the first support member 4A is allowed to be moved in the upward-downward direction Z (particularly in the upward direction) with respect to the housing 3. For example, when the first support member 4A is moved in the upward direction with respect to the housing 3, even when the first support member 4A is moved in the rearward direction due to the biasing force of the biasing member 13, the first shaft support portion 31 of the housing 3 is not fitted into the first recess 41 of the first support member 4A as shown in FIG. 15. That is, the interposing of the biasing member 13 can be released.

In the releasing method of one or more embodiments, by further moving the first support member 4A in the forward direction from a state shown in FIGS. 13 and 14, the first support member 4A can be automatically moved in the upward direction with respect to the housing 3. Hereinafter, this point will be described.

When the first support member 4A is further moved in the forward direction, as shown in FIG. 14, the inclination guide surface 38 of the housing 3 and the inclination guide surface 48 of the first support member 4A come into surface contact with each other. When the first support member 4A is further moved in the forward direction, the inclination guide surface 38 of the housing 3 and the inclination guide surface 48 of the first support member 4A slide to guide the first support member 4A in the upward direction. That is, the first support member 4A is automatically moved in the upward direction with respect to the housing 3.

As described above, according to the ferrule holding structure 1 of one or more embodiments, the biasing member 13 is pressed in the forward direction (+X direction in the case of the first ferrule unit 2A) by utilizing the rotational movement of the support member 4 by the rotation mechanism 5. That is, the biasing member 13 can be pressed in the forward direction by utilizing the principle of the lever. As a result, even when the force for pressing (force for rotating) the support member 4 by the worker is small, the biasing member 13 can be pressed in the forward direction with a large force. As a result, even with a small force, the biasing member 13 having a high spring pressure can be interposed between the housing 3 and the support member 4. Therefore, it is possible to easily assemble the ferrule holding structure 1 on site without any special jigs or devices.

In the ferrule holding structure 1 of one or more embodiments, in a state in which the support member 4 is disposed at the second position P3, the pressing surface 471 of the support member 4 is pressed against the rear end of the biasing member 13. As a result, the biasing member 13 is interposed between the housing 3 and the support member 4. Further, in such a state, the second shaft support portion 32 of the housing 3 and the second recess 42 of the support member 4 restrict the rotational movement of the support member 4 from the second position P3 to the first position P2. Therefore, the support member 4 can be held in a state in which the support member 4 is disposed at the second position P3 against the biasing force of the biasing member 13.

In the ferrule holding structure 1 of one or more embodiments, by moving the support member 4 in the forward direction from the second position P3 against the biasing force of the biasing member 13, the first and second recesses 41 and 42 of the support member 4 can be each separated from the first and second shaft support portions 31 and 32 of the housing 3. As a result, the biasing member 13 can be released from being interposed between the housing 3 and the support member 4. Therefore, in the ferrule holding structure 1 of one or more embodiments, the ferrule 12 and the biasing member 13 (ferrule unit 2) can be attached to or detached from the housing 3.

In the ferrule holding structure 1 of one or more embodiments, the housing 3 and the support member 4 include the inclination guide surfaces 38 and 48. The inclination guide surfaces 38 and 48 move the support member 4 in the upward-downward direction Z (upward direction in one or more embodiments) with respect to the housing 3 as the support member 4 is moved in the forward direction from the second position P3. As a result, simply by moving the support member 4 in the forward direction from the second position P3, the first and second recesses 41 and 42 of the support member 4 can be each positioned to be shifted in the upward-downward direction Z with respect to the first and second shaft support portions 31 and 32 of the housing 3. In such a state, even when the support member 4 is moved in the rearward direction (−X direction in the case of the first ferrule unit 2A) with respect to the housing 3 due to the biasing force of the biasing member 13, the first and second shaft support portions 31 and 32 of the housing 3 are not fitted into the first and second recesses 41 and 42 of the support member 4. Therefore, the biasing member 13 can be simply released from being interposed between the housing 3 and the support member 4.

In the ferrule holding structure 1 of one or more embodiments, the rotation mechanism 5 is provided in the support member 4, and the third recess 43, in which the support member 4 is rotatable around the second shaft support portion 32 when the second shaft support portion 32 is fitted into the third recess 43, is further included. The third recess 43 is positioned in the upward-downward direction Z (downward direction in one or more embodiments) and the forward direction with respect to the second recess 42 in a state in which the support member 4 is disposed at the second position P3. Therefore, after the support member 4 is moved in the forward direction from the second position P3 against the biasing force of the biasing member 13, the support member 4 is further moved in the upward-downward direction Z (upward direction) with respect to the housing 3. In such a state, the second shaft support portion 32 of the housing 3 can be fitted into the third recess 43 of the support member 4 by moving the support member 4 on the rear side by using the biasing force of the biasing member 13. When the second shaft support portion 32 is fitted into the third recess 43, the support member 4 can be rotated with respect to the housing 3 around the second shaft support portion 32. As a result, the pressing surface 471 of the support member 4 can be retracted to a position shifted in the upward direction from the rear end side of the biasing member 13. Therefore, even when the support member 4 is not detached from the housing 3, the ferrule 12 and the biasing member 13 (ferrule unit 2) can be easily inserted into and removed from the housing 3 without being obstructed by the support member 4.

In the ferrule holding structure 1 of one or more embodiments, the optical fiber 11 positioned on the rear side of the ferrule 12 is protected by the tubular member 15. The support member 4 is movable with respect to the housing 3 on the outer peripheral side of the tubular member 15. Therefore, when the support member 4 is moved with respect to the housing 3 on the rear side of the ferrule 12, it is possible to prevent the support member 4 from coming into contact with the optical fiber 11. That is, the optical fiber 11 can be protected from the support member 4 by the tubular member 15.

In the ferrule holding structure 1 of one or more embodiments, the biasing member 13 is positioned in the outer peripheral side of the tubular member 15. As a result, it is possible to prevent the biasing member 13 from coming into contact with the optical fiber 11 on the rear side of the ferrule 12. That is, the optical fiber 11 can be protected from the biasing member 13 by the tubular member 15.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

In one or more embodiments, the housing 3 is not limited to being configured as an adapter to which the two ferrule units 2 and the support member 4 are attached, and for example, the housing 3 may be configured such that only one ferrule unit 2 and the support member 4 can be attached. In this case, the housing 3 is configured as the optical connector together with the one ferrule unit 2 and the support member 4. In the ferrule holding structure 1 constituting the optical connector, the front end portion of the ferrule 12 including the connection surface 121 may be disposed outside the housing 3, for example. That is, the housing 3 may accommodate at least a part of the ferrule 12.

### REFERENCE SIGNS LIST

1: Ferrule holding structure
3: Housing
4: Support member
5: Rotation mechanism
11: Optical fiber
12: Ferrule
13: Biasing member
15: Tubular member
31: First shaft support portion
32: Second shaft support portion
38, 48: Inclination guide surface
41: First recess
42: Second recess
43: Third recess
121: Connection surface
471: Pressing surface
P2: First position
P3: Second position
X: Forward-rearward direction
Y: Left-right direction (first orthogonal direction)
Z: Upward-downward direction (second orthogonal direction)

1. A ferrule holding structure comprising:
an optical fiber;
a ferrule:
into which the optical fiber is inserted from a rear end of the ferrule to a connection surface at a front end of the ferrule, and
that holds the optical fiber;
a biasing member biasing the ferrule in a forward direction from the rear end toward the connection surface;
a housing accommodating the biasing member and at least a part of the ferrule;
a support member engaged with the housing and supporting a rear end side of the biasing member; and
a rotation mechanism, structured with a part of the support member and a part of the housing, that rotatably attaches the support member to the housing, wherein
the support member includes a pressing surface that presses the biasing member in the forward direction along with a rotation of the support member with respect to the housing by the rotation mechanism.

2. The ferrule holding structure according to claim 1, wherein
the rotation mechanism includes:
a first shaft support portion and a second shaft support portion:
disposed in the housing, and
extending in a first orthogonal direction orthogonal to a forward-rearward direction of the ferrule holding structure;
a first recess in the support member, wherein the support member rotates around the first shaft support portion fitted into the first recess; and
a second recess in the support member,
the pressing surface presses the biasing member in the forward direction when the support member rotates around the first shaft support portion from a first position to a second position, and
the second recess restricts rotational movement of the support member from the second position toward the first position when the support member reaches the second position and the second shaft support portion is fitted into the second recess.

3. The ferrule holding structure according to claim 2, wherein
when the support member is at the second position, the first recess is positioned in a forward direction side of the first shaft support portion and the second recess is positioned in the forward direction of the second shaft support portion, and
the support member moves in the forward direction from the second position against a biasing force of the biasing member.

4. The ferrule holding structure according to claim 3, wherein
one of the housing and the support member includes an inclination guide surface inclined in both the forward-rearward direction and a second orthogonal direction orthogonal to the forward-rearward direction and the first orthogonal direction when the support member is at the second position, and
the inclination guide surface faces the other of the housing and the support member in the forward-rearward direction when the support member is at the second position.

5. The ferrule holding structure according to claim 3, wherein
the rotation mechanism further includes a third recess in the support member, wherein the support member rotates around the second shaft support portion fitted into the third recess,
the first shaft support portion is positioned in a rearward direction opposite to the forward direction with respect to the second shaft support portion,
the first recess is positioned in the rearward direction with respect to the second recess, and
when the support member is at the second position, the third recess is positioned:
to be shifted in a second orthogonal direction orthogonal to the forward-rearward direction and the first orthogonal direction with respect to the second recess, and
in the forward direction with respect to the second recess.

6. The ferrule holding structure according to claim 1, further comprising:
a tubular member, disposed on a rear end side of the ferrule, into which the optical fiber extending in the rear side of the ferrule is inserted, wherein
the support member moves with respect to the housing on an outer peripheral side of the tubular member.

7. The ferrule holding structure according to claim 1, further comprising:
a tubular member, disposed on a rear end side of the ferrule, into which the optical fiber extending in the rear side of the ferrule is inserted, wherein
the biasing member is disposed on an outer peripheral side of the tubular member.
